(19) United States
(12) Patent Application Publication
(10) Pub. No.: US 2026/0094040 A1
(43) Pub. Date: Apr. 2, 2026

(54) REVERSE LOG ENCODING FOR QUDIT-BASED QUANTUM ANNEALERS

(71) Applicant: Dell Products L.P., Round Rock, TX (US)

(72) Inventors: Brendan Burns Healy, Haddonfield, NJ (US); Miguel Paredes Quiñones, Campinas (BR)

(21) Appl. No.: 18/884,016

(22) Filed: Sep. 12, 2024

(51) Int. Cl. G06N 10/60; G06N 10/20

(52) U.S. Cl. CPC G06N 10/60; G06N 10/20

(57) ABSTRACT

One example method includes, for a base ‘n’ qudit having ‘x’ possible states, converting each of the ‘x’ states from a decimal form to a binary form, labeling the states as binary, identifying ‘p’ variables of a problem to be solved by a quantum annealer, assigning each of the binary states of the base ‘n’ qudit to a respective variable of the problem, so that each of the binary states represents one variable of the problem, converting respective values of the binary states to integers so that each of the variables corresponds to a respective integer, and solving, by the quantum annealer, the problem, using the base ‘n’ qudit.

### TECHNOLOGICAL FIELD OF THE DISCLOSURE

One or more embodiments disclosed herein generally relate to the use of qudit based systems and devices. More particularly, at least some embodiments relate to systems, hardware, software, computer-readable media, and methods, for efficient utilization of qudit based quantum hardware such as quantum annealers.

### BACKGROUND

Since the initial advent of quantum annealers, which began their lifecycle as a purely binary system, advances have enabled the physical qubits to superpose over more than just two states. To mentally visualize what this means, imagine a singular electron orbiting a nucleus-depending on the atomic number of the element, the electron can exist in a number of different quantum “shells” surrounding the nucleus, and the measurable quantum properties of the electron, such as its spin and location for example, may exist in superposition.

Recent quantum hardware has made use of this additional flexibility by assigning logical meaning to the many different physical states of the quantum system, particularly those states to which the system can collapse upon measurement. QCI (https://quantumcomputinginc.com/) is a quantum hardware vendor that has developed a “quantum adiabatic processor” which can consistently achieve, and reliably differentiate between, 200 separate states for a qubit. For this reason, integer parameter variables with a range of at most 200 such as, for example, [0,199], [204, 403], [−99,100], require only one qubit to be effectively encoded, if questions of connectivity and chains during minor-embedding in real hardware are ignored. A qubit capable of outputting more than 2 possible states is referred to herein as a qudit, consistent with industry convention.

There is a tradeoff however, in that relatively fewer qudits than qubits can be fit in the same chip. This is to be expected however since additional quantum states are associated with more complicated, and therefore larger, quantum systems. Referring back to QCI, their qubit-based Dirac1 housed 11,000 qubits. Their newest device, Dirac3, supports 998 base-200 qudits. Despite a lower number of physical quantum components, it is considered by some as a higher-capacity system. At present, this depends on the nature of the problem fully utilizing the integer-based capacity.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of conventional quantum computing approach that uses qubits to able to handle problems with only binary variables, as compared with a quantum computing approach that uses qudits to handle problems with one or more non-binary variables.

FIG. 2 discloses aspects of an example architecture according to one embodiment.

FIG. 3 discloses aspects of an example schema according to one embodiment.

FIG. 4 discloses aspects of a computing system configured and operable to perform any of the disclosed methods, processes, or operations.

### DETAILED DESCRIPTION OF SOME EXAMPLE EMBODIMENTS

One or more embodiments disclosed herein generally relate to the use of qudit based systems and devices. More particularly, at least some embodiments relate to systems, hardware, software, computer-readable media, and methods, for efficient utilization of qudit based quantum hardware such as quantum annealers.

One or more example embodiments may enable efficient use of qudits of a quantum computing device, such as a quantum annealer. That is, for example, an embodiment may comprise a method that enables a relative increase in the size of problems that may be handled by the qudits of a quantum annealer. To illustrate with one non-limiting example, discussed in more detail elsewhere herein, an embodiment of such a method may, using the same number of qudits as a conventional method, enable the solution of problems with 4× more variables than is possible with conventional methods.

An example method according to one embodiment may be performed by, or at the direction of, quantum hardware such as a quantum annealer, that includes an n-base qudit that can each occupy n−1 different states. In one embodiment, the method may be applied serially, or in parallel, to each of one or more qudits, and may be performed with respect to a natively binary problem that has multiple binary variables, such as e, f, g, and h, for example, that each have a value of 0 or 1 in the output or solution.

Given this background, a method according to one embodiment may comprise the following operations: converting each possible state of the n-base qudit to a binary value; labeling each of the states as binary; identifying variables of the problem, which may be a QUBO (quadratic unconstrained binary optimization) problem, to be solved; assigning each of the state binary values to a respective one of the variables, such that the qudit then represents all of the variables; and, solving a problem using the qudit, wherein the solving includes converting the binary state values to respective integers, so that each variable corresponds to an integer value.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that the capacity of a qudit-based device may be expanded. An embodiment may automatically transpile logical variables into physical qudit combinations. Various other advantages of one or more embodiments will be apparent from this disclosure.

### A. CONTEXT FOR AN EXAMPLE EMBODIMENT

### A.1 Qudits on Photonic Computers

A photon has many quantum properties such as the orbital angular momentum, frequency-bin and time-bin that can be used to represent a qudit without the interference on states as in other qudits implementations. One of the simplest way to encode a qudit in an optical system is to use d different optical modes, labeled by the numbers 0, 1, . . . , d−1, and map the qudit levels to the occupation of different modes via the mapping:

$${{{{\vert i 〉 \to \vert 0 〉}_{0} \vert 0 〉}_{1} … \vert 1 〉}_{i} … \vert 0 〉}_{d - 1} ,$$

where |i [symbol] denotes the d different qudit levels.

### A.2 Dirac-2

Dirac-2 is the first generation of the QUDIT EQC, it uses the same physical system explained previously that solves unconstrained integer optimization problems that has objective Function (Min/Max)imization.

The expected return of the energy function is:

$$E = {\sum }_{i = 1}^{N} {C}_{i} {V}_{i} + \sum {\sum }_{1 \leq i < j \leq N}^{N , N} {J}_{i j} {V}_{j} {V}_{j}$$

under the constraint of a fixed resource

$$R = {\sum }_{i = 1}^{N} {V}_{i} ,$$

where Vᵢ is the value of each variable, and where Cᵢ is the linear coefficient of each variable, Cᵢ∈ [symbol] , Jᵢⱼ is the coupling coefficient of two variables, Jᵢⱼ∈ [symbol] .

### A.3 Problems

A known problem is that the capacity of qudit-based machines is typically underutilized. This is due at least in part to the fact that each qudit in these machines is used to represent only two different states. This is problematic since problems may have thousands, or more, variables. This underutilization of qudit-based machines thus limits the ability of these machines to solve problems. Such underutilization may also result any time integers have a range smaller than the number of qudit levels, but a reference to “two different states” implicitly refers to a QUBO problem. Further, because these machines tend to be expensive, a business or other enterprise may not be able to purchase the necessary capacity to solve problems on premises.

### B. ASPECTS OF EXAMPLE ARCHITECTURES FOR ONE EMBODIMENT

The following is a discussion of aspects of example architectures for one embodiment. This discussion is not intended to limit the scope of the claims or this disclosure, or the applicability of the embodiments, in any way.

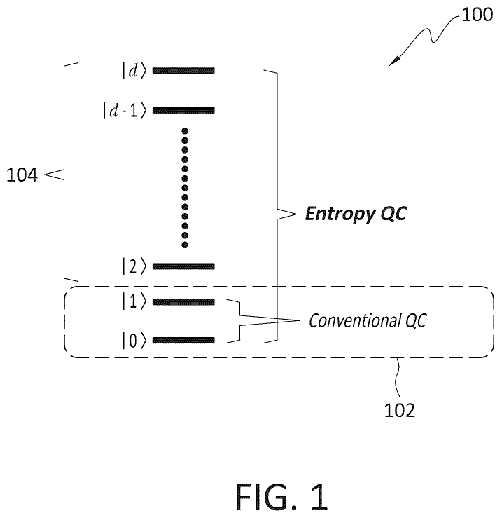

With reference to FIG. 1, there is disclosed an architecture 100 of a quantum device such as a quantum annealer. As shown, the example architecture 100 may comprise conventional qubits 102 of a quantum computing device, such as a quantum annealer for example. The qubits are binary in the sense that they have only two possible states, indicated as ‘0’ and ‘1’ in FIG. 1. The example architecture 100 may additionally, or alternatively, comprise one or more qudits 104 that have >2 possible states, as shown at states | 2) . . . |d). A method according to one embodiment may be implemented in connection with a device that comprises one or more qudits, such as the qudits 104 for example.

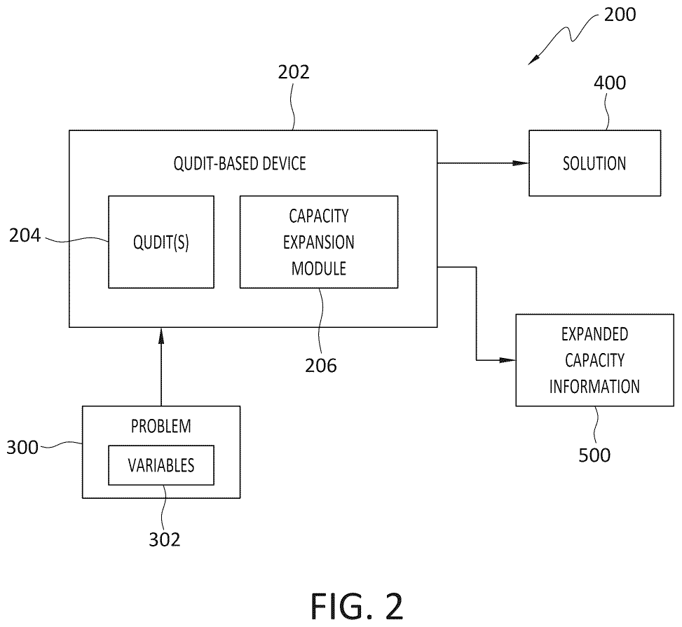

Turning next to FIG. 2, another architecture 200 is disclosed that comprises a qudit-based device 202. In an embodiment, the architecture 100 may be subsumed within, or comprise, the qudit-based device 202. Likewise, in an embodiment, the qudit-based device 202 may comprise an architecture such as the architecture 100.

The example qudit-based device 202 may comprise one or more qudits 204, and a capacity expansion module 206 which may be operable to perform any one or more of the disclosed methods, processes, and operations. In an embodiment, the capacity expansion module 206 may be hosted outside the qudit-based device 202 and may, or may not, be controlled by the qudit-based device. The qudit-based device 202 may receive various inputs, and generate various outputs.

For example, the qudit-based device 202 may, in operation, receive a problem 300 that may comprise one or more variables 302. The variables 302 may be binary in nature and in one or more embodiments, a problem 300 may comprise any number of variables greater than 2. In one embodiment, the problem 300 comprises a QUBO problem, and/or a QUBO matrix. Upon receipt of the problem 300, the qudit-based device 202 may initialize the capacity expansion module 206 to determine how many qudits are needed to solve the problem 300. In an embodiment, an orchestration process may be performed to orchestrate the problem 300 to the qudits needed for solution. Each of the qudits may have any number of states greater than 2. In this way, the fewest possible number of qudits needed to solve the problem 300 may be employed. Thus, the respective maximum capacities, or near-maximum capacities, of the qudits used to solve the problem may be employed, resulting in efficient use of those qudits, while also leaving a relatively larger number of the remaining qudits available for other problems and processes.

In an embodiment, the qudit-based device 202 may output a solution 400 to the problem 300. As well, expanded capacity information 500 generated by the capacity expansion module 206 may be output as well. This expanded capacity information may comprise, for example, an identification of the qudits that were used to solve the problem 300, and the extent to which the respective capacity of each of those qudits was employed in the problem 300 solution.

### C. DETAILED DISCUSSION OF ASPECTS OF ONE EMBODIMENT

### C.1 Background—Log Encoding

By way of background, it is worth noting how integer parameters are reformed into binary variables in a traditional QUBO-based approach. In particular, log encoding is described in https://pyqubo.readthedocs.io/en/latest/reference/integer.html#pyqubo.LogEncInteger, which is incorporated herein in its entirety by this reference.

This log encoding approach uses a binary representation of the variable. Suppose variable X needs to take on a range of between 0 and Xₘₐₓ inclusive. Then, N=[log₂(Xₘₐₓ)] binary variables xᵢ may be created:

$$X = {\sum }_{i = 0}^{N} {x}_{i} \cdot {2}^{i} + ( {X}_{max} + 1 - {2}^{N + 1} ) \cdot {x}_{N + 1}$$

Note that the coefficient of the last variable is only as large as it needs to be to hit the top end of the range (Xₘₐₓ, when all binary variables equal 1), and is not a power of two, unless it happens that the range ends in one less than a power of two. So, as an example, a variable needing to span the range [10,20] would be assigned X=10+1·x0+2·x1+4·x2+3·x3, where xi are binary.

### C.2 Example Embodiment

One example embodiment comprises a method that essentially performs a log encoding process, but in reverse. Consider, for example, a case where a qudit-based device is being used. For purposes of simplifying the explanation, without sacrificing any generality, assume the qudit base is 16, so that each qudit can occupy one of 15 different states. By way of comparison, a conventional qubit can only occupy one of 2 states. The conventional way to label these states, in the case of a base 16 qudit, would be {0, 1, . . . , j, . . . , 15}. Following is a discussion of the operations of an example embodiment that implements a different approach:
(1) In one embodiment, these states will, instead, be labeled {0000, 0001, 0010, . . . , bin (j), . . . , 1111}, where bin(•) is a function that converts a decimal value to a binary value;
(2) Further suppose that a problem needed to be solved is a natively binary problem, such as the traveling salesman, QAP, or knapsack, problems, where all variables will be either 0 or 1 in the output, that is, the solution;
(3) Next, label these variables {w, x, y, z}, keeping in mind that these 4 binary variables may, but do not need to, have a logical relationship to each other in the original problem;
(4) Now, assign each state of a qudit (labelled A for ease of reference) to a complete assignment of values to w, x, y, z—without loss of generality, this can be done as follows:

$$A = 0000 ← \to w = x = y = z = 0 or dec ( 0000 ) = 0 , A = 0001 ← \to w = x = y = 0 , z = 1 or dec ( 0001 ) = 1$$

$$A = 0010 ← \to w = x = z = 0 , y = 1 or dec ( 0010 ) = 2 … A = 1111 ← \to w = x = y = z = 1 or dec ( 1111 ) = 15$$

The result of these operations (1) through (4) is that now a single qudit is used to represent 4 different variables of a problem, rather than only 2 variables as in a conventional approach; and
(5) Finally, a function dec(•) may be defined and implemented that takes a binary input, such as a binary state value, and converts that binary input to an integer.

In the illustrative, and non-limiting, example above, a machine, such as a quantum annealer for example, with a capacity for 1,000 base-16 qudits would be able to solve problems that have as many as 4000 binary variables, that is, 4 variables per each base-16 qudit. In contrast, the use of conventional methods with such a machine would only permit solution of problems with up to 1000 variables, of any size, that is, only 1 variable per each base-16 qudit.

### C.3 Conversions

It is noted that in an embodiment, it is possible to perform the conversion, of qudit states to an integer number of variables, using any base. In particular, if a problem uses variables with base K, and the hardware to be used to solve the problem accepts variables with base M, then an embodiment may define a function ƒ_{K,M} which has, as its domain, integers represented as strings using the digits {1 . . . K}, and range integers represented as strings {1 . . . M}. The function “dec(•)” noted above is used in connection with a particular instance where K=2, M=10. As another example, suppose K=3 and M=50, then the maximum number of digits in a string representing an integer would be Xmax=[log₃(50)]=4. Thus, this embodiment can use a 50 qudit quantum computer to represent 4 integer variables, where every base 3 variable can have values between 0 to 2. Then, as examples of possible states, there would be the following:

$$A = 0 \; 000 ← \to w = x = y = z = 0 or {f}_{3 , 50} ( 0000 ) = 0 , A = 0 \; 001 ← \to w = x = y = 0 , z = 2 or {f}_{3 , 50} ( 0001 ) = 2$$

$$A = 0020 ← \to w = x = z = 0 , y = 2 or {f}_{3 , 50} ( 0020 ) = 6 … A = 1 \; 111 ← \to w = x = y = z = 1 or {f}_{3 , 50} ( 1111 ) = 40$$

It is noted that a conversion is only ‘optimal’ when there is a perfect correspondence between the qudit capacity, and the base of the variables being represented. In the illustrative example above, the conversion is optimal because the qudit has a power of 2 for a base, that is 2⁴=16 base qudit, and 2²=4 for the number of variables that can be represented by a single qudit having a base of a power of 2. In other circumstances, there may be some unused qudit capacity in the implementation of this procedure, although the qudit capacity that is employed would still exceed what would be possible with conventional approaches.

### C.4 Constraints in the Encoding Function

A method according to one embodiment may represent problem constraints directly in an encoding function. For example, if the constraint is:

$$w + x + y + z = 1 ,$$

then the only possible values (using the example above of the qudit A encoding the binary variables w, x, y, z) of the qudit A are as follows:

$$A = 0 \; 001 ← \to w = x = y = 0 , z = 1 or dec ( 0001 ) = 1 , A = 0001 ← \to w = y = z = 0 , x = 1 or dec ( 0100 ) = 3$$

$$A = 0100 ← \to w = x = z = 0 , y = 1 or dec ( 0010 ) = 2 , A = 1 \; 000 ← \to x = y = z = 0 , w = 1 or dec ( 1000 ) = 4$$

Thus an embodiment may encode the constraint, which is a one-hot binary constraint in this example, in the variables w, x, y, z above in the qudit architecture by restricting the qudit A to the values {1,2,3,4} with a different dec(•) function. Note that one-hot encoding refers to an encoding approach in which only 1 bit is used to represent a particular state. In this example, an embodiment may use a qudit with a maximum value of 4 possible states, but if the embodiment were to use dec(•) s a regular binary to decimal conversion, then a qudit with a maximum value of 8 possible states (1000 in decimal) would be required to represent the 4 variables.

One example implementation of dec(•) may be used to inspect the constraints and organize the allowed values of the qudit consecutively, so as to improve the hardware performance for example. In an embodiment, the encoding function may implemented on a per-qudit basis, assuming the encoding is stored somewhere on a classical computing platform to enable decoding during a post-processing step. By implementing encoding on a per-qudit basis, an embodiment may enable a high degree of customization in terms of the utilization of the qudits of a particular machine.

### D. ASPECTS OF AN EXAMPLE SCHEMA

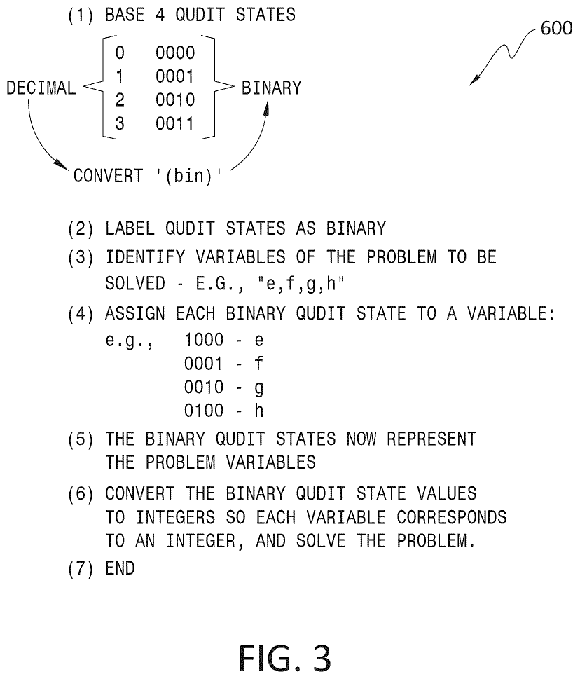

With attention next to FIG. 3, aspects of a schema 600 according to one embodiment are disclosed. The schema 600 is presented by way of example and is not intended to limit the scope of this disclosure, or any claim, in any way. In an embodiment, the schema 600 may be implemented as a method, such as that described earlier herein. It is noted, with respect to this example schema 600, that multiple binaries can be one simultaneously, for example, f=g=1, e=h=0 corresponds to “0011” in the schema 600 of FIG. 3.

### E. FURTHER DISCUSSION

As disclosed herein, one or more embodiments may possess various useful features and aspects, although no embodiment is required to possess any of such features or aspects. The following examples are illustrative but not exhaustive. An embodiment may expand the capacity of qudit-based devices by assigning additional logical meaning to extra states of quantum components. An embodiment may comprise a mechanism operable to automatically transpile logical variables into physical qudit combinations based on the range of the logical variable and the capacity of the qudit. In an embodiment, this mechanism and its operation may be made transparent to the user, for the sake of simplicity.

### F. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. FURTHER EXAMPLE EMBODIMENTS

Following are some further example embodiments. These are presented only by way of example and are not intended to limit the scope of this disclosure or the claims in any way.

Embodiment 1. A method, comprising: for a base ‘n’ qudit having ‘x’ possible states, converting each of the ‘x’ states from a decimal form to a binary form; labeling the states as binary; identifying ‘p’ variables of a problem to be solved by a quantum annealer; assigning each of the binary states of the base ‘n’ qudit to a respective variable of the problem, so that each of the binary states represents one variable of the problem; converting respective values of the binary states to integers so that each of the variables corresponds to a respective integer; and solving, by the quantum annealer, the problem, using the base ‘n’ qudit.

Embodiment 2. The method as recited in any preceding embodiment, wherein the problem comprises a QUBO (quadratic unconstrained binary optimization) problem.

Embodiment 3. The method as recited in any preceding embodiment, wherein the variables ‘p’ of the problem are base K, the quantum annealer accepts variables with base M, and a function ƒ_(K,M) is defined which has, as its domain, integers represented as strings using the following digits {1 . . . K}, and range integers represented as strings {1 . . . M}.

Embodiment 4. The method as recited in any preceding embodiment, wherein a number of the ‘x’ states of the qudit is greater than two.

Embodiment 5. The method as recited in any preceding embodiment, wherein the variables are automatically transpiled into the qudit states.

Embodiment 6. The method as recited in any preceding embodiment, wherein one or more constraints of the problem are represented in the converting of the binary state values to integers so as to limit a number of possible binary state values of the base ‘n’ qudit.

Embodiment 7. The method as recited in any preceding embodiment, wherein when a value of the base ‘n’ is not equal to a base of the ‘p’ variables, a portion of a capacity of the qudit remains unused when the problem is being solved.

Embodiment 8. The method as recited in any preceding embodiment, wherein the problem is a natively binary problem.

Embodiment 9. The method as recited in any preceding embodiment, wherein an optimal correspondence between a capacity of the base ‘n’ qudit and the ‘p’ variables when both the base ‘n’ qudit and a base of the ‘p’ variables is the same.

Embodiment 10. The method as recited in any preceding embodiment, wherein the converting of the binary state values to integers is performed on a per-qudit basis.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

In one or more embodiments, a computing system may comprise classical hardware, quantum hardware such as quantum annealers of various types, or a combination of classical hardware and quantum hardware. Where quantum hardware is employed in a computing system, such quantum hardware may comprise qubits and/or qudits.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

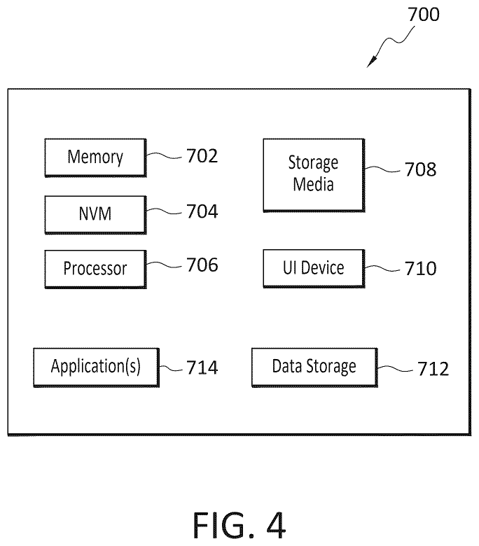

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 4.

In the example of FIG. 4, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for expanding a capacity of a qudit, comprising:
for a base ‘n’ qudit having ‘x’ possible states, converting each of the ‘x’ states from a decimal form to a binary form;
labeling the states as binary;
identifying ‘p’ variables of a problem to be solved by a quantum annealer;
assigning each of the binary states of the base ‘n’ qudit to a respective variable of the problem, so that each of the binary states represents one variable of the problem;
converting respective values of the binary states to integers so that each of the variables corresponds to a respective integer; and
solving, by the quantum annealer, the problem, using the base ‘n’ qudit.

2. The method as recited in claim 1, wherein the problem comprises a QUBO (quadratic unconstrained binary optimization) problem.

3. The method as recited in claim 1, wherein the variables ‘p’ of the problem are base K, the quantum annealer accepts variables with base M, and a function ƒ_{K,M} is defined which has, as its domain, integers represented as strings using the following digits {1 . . . K}, and range integers represented as strings {1 . . . M}.

4. The method as recited in claim 1, wherein a number of the ‘x’ states of the qudit is greater than two.

5. The method as recited in claim 1, wherein the variables are automatically transpiled into the qudit states.

6. The method as recited in claim 1, wherein one or more constraints of the problem are represented in the converting of the binary state values to integers so as to limit a number of possible binary state values of the base ‘n’ qudit.

7. The method as recited in claim 1, wherein when a value of the base ‘n’ is not equal to a base of the ‘p’ variables, a portion of a capacity of the qudit remains unused when the problem is being solved.

8. The method as recited in claim 1, wherein the problem is a natively binary problem.

9. The method as recited in claim 1, wherein an optimal correspondence between a capacity of the base ‘n’ qudit and the ‘p’ variables when both the base ‘n’ qudit and a base of the ‘p’ variables is the same.

10. The method as recited in claim 1, wherein the converting of the binary state values to integers is performed on a per-qudit basis.

11. A non-transitory storage medium having stored therein instructions that are executable by one or more hardware processors to perform operations comprising:
for a base ‘n’ qudit having ‘x’ possible states, converting each of the ‘x’ states from a decimal form to a binary form;
labeling the states as binary;
identifying ‘p’ variables of a problem to be solved by a quantum annealer;
assigning each of the binary states of the base ‘n’ qudit to a respective variable of the problem, so that each of the binary states represents one variable of the problem;
converting respective values of the binary states to integers so that each of the variables corresponds to a respective integer; and
solving, by the quantum annealer, the problem, using the base ‘n’ qudit.

12. The non-transitory storage medium as recited in claim 11, wherein the problem comprises a QUBO (quadratic unconstrained binary optimization) problem.

13. The non-transitory storage medium as recited in claim 11, wherein the variables ‘p’ of the problem are base K, the quantum annealer accepts variables with base M, and a function ƒ_{K,M} is defined which has, as its domain, integers represented as strings using the following digits {1 . . . K}, and range integers represented as strings {1 . . . M}.

14. The non-transitory storage medium as recited in claim 11, wherein a number of the ‘x’ states of the qudit is greater than two.

15. The non-transitory storage medium as recited in claim 11, wherein the variables are automatically transpiled into the qudit states.

16. The non-transitory storage medium as recited in claim 11, wherein one or more constraints of the problem are represented in the converting of the binary state values to integers so as to limit a number of possible binary state values of the base ‘n’ qudit.

17. The non-transitory storage medium as recited in claim 11, wherein when a value of the base ‘n’ is not equal to a base of the ‘p’ variables, a portion of a capacity of the qudit remains unused when the problem is being solved.

18. The non-transitory storage medium as recited in claim 11, wherein the problem is a natively binary problem.

19. The non-transitory storage medium as recited in claim 11, wherein an optimal correspondence between a capacity of the base ‘n’ qudit and the ‘p’ variables when both the base ‘n’ qudit and a base of the ‘p’ variables is the same.

20. The non-transitory storage medium as recited in claim 11, wherein the converting of the binary state values to integers is performed on a per-qudit basis.
